(19) United States
(12) Patent Application Publication
(10) Pub. No.: US 2025/0047374 A1
(43) Pub. Date: Feb. 6, 2025

(54) METHOD AND APPARATUS FOR SATELLITE SWITCHING IN NON-TERRETRIAL NETWORK

(71) Applicant: ELECTRONICS AND TELECOMMUNICATIONS RESEARCH INSTITUTE, Daejeon (KR)

(72) Inventor: Gweon Do JO, Daejeon (KR)

(73) Assignee: ELECTRONICS AND TELECOMMUNICATIONS RESEARCH INSTITUTE, Daejeon (KR)

(21) Appl. No.: 18/792,431

(22) Filed: Aug. 1, 2024

(30) Foreign Application Priority Data
Aug. 2, 2023 (KR) 10-2023-0100974
Jul. 5, 2024 (KR) 10-2024-0089095

(51) Int. Cl. H04B 7/185; H04L 1/1812; H04W 56/00

(52) U.S. Cl. CPC H04B 7/18541; H04B 7/18589; H04L 1/1812; H04W 56/0045

(57) ABSTRACT

The present disclosure provides a satellite switching technique in a non-terrestrial network. A method of a terminal may comprise: obtaining, from a first satellite, uplink (UL) timing advance (TA)-related information for a second satellite; performing satellite switching from the first satellite to the second satellite; and performing communication with the second satellite based on the UL TA-related information.

### CROSS-REFERENCE TO RELATED APPLICATIONS

This application claims priority to Korean Patent Applications No. 10-2023-0100974, filed on Aug. 2, 2023, and No. 10-2024-0089095, filed on Jul. 5, 2024, with the Korean Intellectual Property Office (KIPO), the entire contents of which are hereby incorporated by reference.

### BACKGROUND

### 1. Technical Field

The present disclosure relates to a technique for satellite switching in a non-terrestrial network, and more particularly, to a satellite switching technique for a non-terrestrial network, which facilitates prompt acquisition of synchronization between a terminal and a switched satellite when the satellite is switched without changing a physical cell identifier (PCI).

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, as the 5G mobile communication era begins, the scope of mobile communication services has expanded beyond terrestrial areas to include non-terrestrial areas, such as satellites, and standardization for NR-based non-terrestrial networks (NTN) is underway. In such NTNs, cells supported by orbiting satellites may experience frequent handovers as well as feeder link switching due to the mobility of the satellites. Consequently, handover-related signaling occurring simultaneously from a large number of terminals may place a burden on the non-terrestrial communication system. To improve the situation, the 3GPP is discussing various handover methods, such as group handover, common handover, random access channel-less (RACH-less) handover, and the unchanged physical cell identifier (PCI) method. The unchanged PCI method among the various handover techniques may significantly reduce signaling overhead and may require specific measures to acquire uplink (UL) synchronization after satellite switching.

### SUMMARY

The present disclosure for resolving the above-described problems is directed to providing satellite switching methods and apparatuses for a non-terrestrial network, which facilitate prompt acquisition of synchronization between a terminal and a switched satellite when the satellite is switched without changing a PCI.

A satellite switching method in a non-terrestrial network, according to a first exemplary embodiment of the present disclosure for achieving the above-described objective, may comprise, as a method of a terminal: obtaining, from a first satellite, uplink (UL) timing advance (TA)-related information for a second satellite; performing satellite switching from the first satellite to the second satellite; and performing communication with the second satellite based on the UL TA-related information.

The UL TA-related information may include at least one of information related to a network-controlled common TA for calculating a UL TA for the second satellite or information related to a TA estimated by the terminal.

The information related to the network-controlled common TA may include at least one of a common TA, a primary change amount parameter for the common TA, or a second change amount parameter for the common TA.

The information related to the TA estimated by the terminal may include information on an epoch time and ephemeris-related information.

In the performing of the communication with the second satellite, the terminal may determine a UL TA for the second satellite based on the UL TA-related information after switching to the second satellite, and apply the determine UL TA to the communication with the second satellite.

The method may further comprise: determining whether uplink data exists in a hybrid automatic repeat request (HARQ) buffer of the first satellite; in response to determining that uplink data exists in the HARQ buffer, suspending transmission of the uplink data existing in the HARQ buffer in the performing of the satellite switching; and transmitting the uplink data stored in the HARQ buffer after the satellite switching to the second satellite.

The first satellite and the second satellite may be connected to a same base station, the first satellite may form a first quasi-Earth-fixed cell and the second satellite may form a second quasi-Earth-fixed cell, a physical cell identifier (PCI) of the first quasi-Earth-fixed cell may be equal to a PCI of the second quasi-Earth-fixed cell, and a frequency resource through which a first synchronization signal block (SSB) received by the terminal is transmitted from the first satellite based on the first quasi-Earth-fixed cell may be equal to a frequency resource through which a second SSB received by the terminal is transmitted from the second satellite based on the second quasi-Earth-fixed cell.

The performing of the communication with the second satellite may comprise: stopping communication services of the first satellite based on the satellite switching; connecting to the second satellite based on the satellite switching; and performing the communication with the second satellite through a service link based on the UL TA-related information.

The performing of the communication with the second satellite may comprise: connecting to the second satellite based on the satellite switching; stopping communication services of the first satellite after connecting to the second satellite; and performing the communication with the second satellite through a service link based on the UL TA-related information.

A satellite switching method in a non-terrestrial network, according to a second exemplary embodiment of the present disclosure for achieving the above-described objective, may comprise, as a method of a base station: providing communication services to a terminal connected via a serving satellite; generating uplink (UL) timing advance (TA)-related information for a target satellite; and providing the UL TA-related information to the terminal via the serving satellite.

The base station may transmit the UL TA-related information to the terminal by including the UL TA-related information in a system information block (SIB) 19.

The UL TA-related information may include at least one of information related to a network-controlled common TA for calculating a UL TA for the target satellite or information related to a TA estimated by the terminal.

The information related to the network-controlled common TA may include at least one of a common TA, a primary change amount parameter for the common TA, or a secondary change amount parameter for the common TA.

The information related to the TA estimated by the terminal may include information on an epoch time and ephemeris-related information.

The method may further comprise: performing satellite switching of a satellite providing communication services to the terminal from the serving satellite to the target satellite; and providing communication services to the terminal via the target satellite based on the UL TA-related information for the target satellite.

A satellite switching apparatus, as a terminal, in a non-terrestrial network, according to a third exemplary embodiment of the present disclosure for achieving the above-described objective, may comprise a processor, and the processor may cause the terminal to perform: obtaining, from a first satellite, uplink (UL) timing advance (TA)-related information for a second satellite; performing satellite switching from the first satellite to the second satellite; and performing communication with the second satellite based on the UL TA-related information.

The UL TA-related information may include at least one of information related to a network-controlled common TA for calculating a UL TA for the second satellite or information related to a TA estimated by the terminal.

The information related to the network-controlled common TA may include at least one of a common TA, a primary change amount parameter for the common TA, or a second change amount parameter for the common TA.

The information related to the TA estimated by the terminal may include information on an epoch time and ephemeris-related information.

In the performing of the communication with the second satellite, the processor may cause the terminal to determine a UL TA for the second satellite based on the UL TA-related information after switching to the second satellite, and apply the determine UL TA to the communication with the second satellite.

According to the present disclosure, a terminal in a radio resource control (RRC) connected state can obtain in advance information needed to acquire UL synchronization with a replacement satellite before a satellite hard switching (SHS) occurs. Furthermore, the terminal can quickly acquire UL synchronization with the replacement satellite during satellite switching without changing a PCI in the NTN. Additionally, according to the present disclosure, the terminal can avoid temporary service interruption due to handovers.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a first exemplary embodiment of an unchanged PCI method.

FIG. 5 is a flow chart illustrating a first exemplary embodiment of a satellite switching method in a non-terrestrial network.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

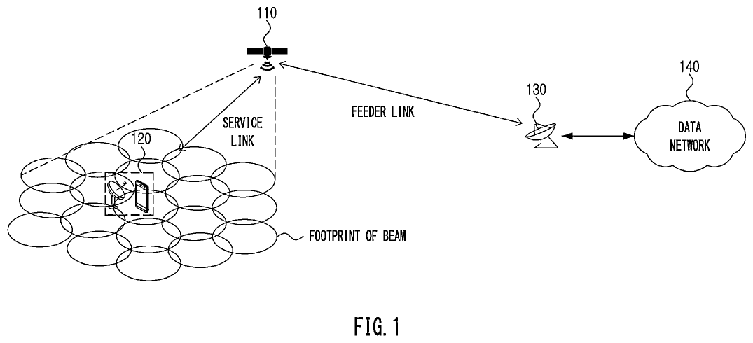

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

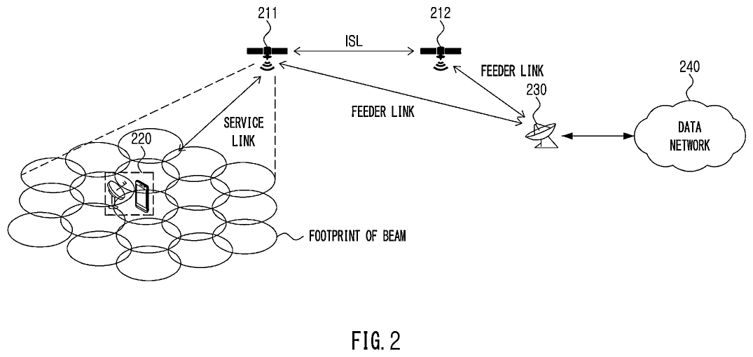

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

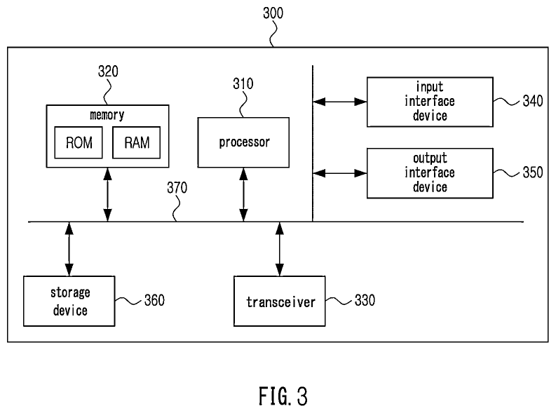

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel bandwidth | 30 MHz for band <6 GHz | |
| capability | 1 GHz for band >6 GHz | |
| (service link) | | |
| Maximum distance between | 40,581 km | 1,932 km (altitude of 600 km) |
| satellite and communication | | 3,131 km (altitude of 1,200 km) |
| node (e.g. UE) at the minimum | | |
| elevation angle | | |
| Maximum round trip delay | Scenario A: 541.46 ms (service | Scenario C: (transparent |
| (RTD) | and feeder links) | payload: service and feeder |
| (only propagation delay) | Scenario B: 270.73 ms (only | links) |
| | service link) | −5.77 ms (altitude of 60 0 km) |
| | | −41.77 ms (altitude of 1,200 km) |
| | | Scenario D: (regenerative |
| | | payload: only service link) |
| | | −12.89 ms (altitude of 600 km) |
| | | −20.89 ms (altitude of 1,200 |
| | | km) |
| Maximum delay variation | 16 ms | 4.44 ms (altitude of 600 km) |
| within a single beam | | 6.44 ms (altitude of 1,200 km) |
| Maximum differential delay | 10.3 ms | 3.12 ms (altitude of 600 km) |
| within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a | 541.75 ms | 270.57 ms | 28.41 ms | 12.88 ms |
| radio interface between | (worst case) | | | |
| base station and UE | | | | |
| Minimum RTD in a | 477.14 ms | 238.57 ms | 8 ms | 4 ms |
| radio interface between | | | | |
| base station and UE | | | | |

Meanwhile, as the 5G mobile communication era begins, the scope of mobile communication services has expanded beyond terrestrial areas to include non-terrestrial areas, such as satellites. The 3GPP, a representative mobile communication standardization organization, has completed the 5G NR standardization in Release-15, and is in the process of standardizing NR-based non-terrestrial network (NTN) as one of the directions of NR evolution to revitalize 5G and expand the ecosystem. The NTN aims to provide wide-area coverage capabilities and cost-effective 5G services in areas not served by terrestrial 5G networks (e.g. isolated or remote areas, aircraft or ships, and passengers) and underserved areas (e.g. suburban or rural areas).

The 3GPP began treating NTN as a study item starting with Release-15, announced the NTN specifications for the first time in Release-17, and is currently conducting standardization works to improve the NTN specifications in Release-18. Improvement of uplink performance may be a key standardization issue in Release-18. In Release-18, the 3GPP is discussing solutions to improve the performance of physical uplink control channel (PUCCH) by repeatedly transmitting hybrid automatic repeat request acknowledgment (HARQ-ACK) during the initial access stage of a commercial smartphone to a low-orbit satellite. Additionally, the 3GPP is discussing solutions to enhance UE positioning functions of NTN due to the raised need for networks to verify the location of terminals for services such as public safety in Release-18. Furthermore, in Release-18, the 3GPP is exploring measurement relaxation measures to reduce power consumption during cell reselection of terminals between NTN-TN cells and cell reselection methods of terminals between NTN-NTN cells in an Earth-moving cell environment.

In such NTNs, cells supported by orbiting satellites may experience frequent handovers as well as feeder link switching due to the mobility of the satellites. Consequently, handover-related signaling occurring simultaneously from a large number of terminals may place a burden on the non-terrestrial communication system. To improve this, the 3GPP is discussing various handover methods such as group handover, common handover, random access channel less (RACH-less) handover, and unchanged physical cell identifier (PCI) method. The unchanged PCI method among the various handover methods may be a method to significantly reduce signaling overhead.

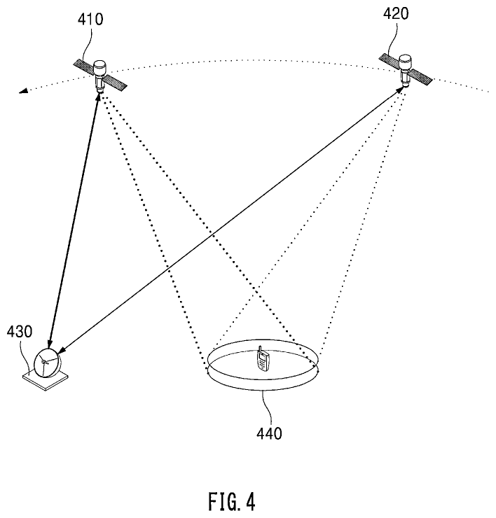

FIG. 4 is a conceptual diagram illustrating a first exemplary embodiment of an unchanged PCI method.

Referring to FIG. 4, a first satellite 410 and a second satellite 420 may be neighbor satellites belonging to the same orbit. In this case, the second satellite 420 orbiting adjacent to the first satellite 410 may be connected to the same gateway 430 or base station that the first satellite 410 is connected to. The first satellite 410 and the second satellite 420 may be transparent satellites that comply with the 3GPP NTN specifications and may form Earth-fixed cells.

The first satellite 410 may stop providing services to a service coverage 440 as it moves. Then, the second satellite 420 may take over the services for the service coverage 440. At this time, the second satellite 420 may be connected or in the process of connecting to the gateway 430 or base station to which the first satellite 410 is already connected. Accordingly, through antenna beam adjustment, the second satellite 420 may use a next beam to serve the same service coverage as the service coverage 440 that a beam of the first satellite 410 previously served. Here, the service coverage 440 may be a cell coverage served by the first satellite 410 or the second satellite 420.

Accordingly, after the satellite serving the service coverage 440 is switched from the first satellite 410 to the second satellite 420, most cell configuration information such as PCI, frequency, and common serving cell configuration may be maintained without change. As described above, cell configuration information for terminals located in the service coverage 440 may not change even when the serving satellite is switched from the first satellite 410 to the second satellite 420. Therefore, it may be possible for the terminals not to change information such as serving cell configuration. In addition, the terminals may not need to change base station resources due to the satellite switching. At this time, the terminals may be in a radio resource control (RRC) connected state. In this case, the first satellite 410 may form a first quasi-Earth-fixed cell, and the second satellite 420 may form a second quasi-Earth-fixed cell. A PCI of the first quasi-Earth-fixed cell and a PCI of the second quasi-Earth-fixed cell may be the same. In addition, a frequency resource through which a first synchronization signal block (SSB) received by the terminals is transmitted from the first satellite 410 based on the first quasi-Earth-fixed cell may be the same as a frequency resource through which a second SSB received by the terminals is transmitted from the second satellite 420 based on the second quasi-Earth-fixed cell.

From the network perspective, satellites operating with transparent payloads may be considered similar to moving antennas that primarily provide access to terminals. From the terminal perspective, except for some information such as ephemeris and timing synchronization, it may seem as if the cell has not changed even during satellite switching. These cells may be referred to as unchanged PCI cells, that is, cells whose PCI has not been changed.

As long as a terminal does not leave the unchanged PCI cell, the NTN can provide services to the terminal without handover. Accordingly, the NTN can significantly reduce signaling overhead due to handovers, which has been pointed out as a problem of NTNs. If the terminal leaves the unchanged PCI cell, the terminal may perform a normal handover. The unchanged PCI method can provide the advantage of significantly reducing signaling overhead by reducing frequent handovers in the Earth-fixed cell scenario. If times when the first satellite 410 and the second satellite 420 provide services to the same Earth-fixed cell overlap, the satellite switching may be referred to as ‘soft switching’, and if they do not overlap, the satellite switching may be referring to as ‘hard switching’.

Despite the advantages mentioned above, detailed procedures for the unchanged PCI method have not yet been completed, and various discussion issues may remain. In particular, in the unchanged PCI method, a specific method for acquiring UL synchronization after satellite switching has not been determined. The present disclosure relates to the unchanged PCI method. Here, the unchanged PCI method may be one of the measures to significantly reduce signaling overhead when handover is required in the Earth-fixed cell scenario. As described above, the detailed procedures for the unchanged PCI method have not yet been completed. Therefore, the present disclosure is directed to proposing an unchanged PCI method. More specifically, the present disclosure is focused on providing techniques for quickly acquiring uplink synchronization between the switched satellite and the terminal in situations where satellite beams are operated for Earth-fixed cells, and the satellites are hard switched without changing the gateway or base station.

The 3GPP has agreed to broadcast information to terminals via a system information block (SIB) from a serving cell regarding an expected service interruption time of a serving satellite due to satellite hard switching (SHS), an expected service start time of a target satellite (i.e. switched satellite), and whether a satellite to be switched (i.e. replacement satellite) supports the unchanged PCI method. However, the 3GPP may not have yet discussed more specific procedures for performing the SHS without changing the PCI. Accordingly, the present disclosure proposes detailed methods required to quickly perform the SHS without changing the PCI.

A terminal in the RRC connected state may need to quickly acquire DL/UL synchronization with a newly switched satellite in order to continue receiving services immediately after the SHS. In order to acquire UL synchronization with the newly switched satellite, the terminal may require a value of TTA, which represents a UL timing advance (TA). According to the 3GPP specifications, the value of TTA may be derived according to Equation 1 below.

$${T}_{T A} = ( {N}_{T A} + {N}_{TA , offset} + {N}_{TA , adj}^{c o m m o n} + {N}_{TA , adj}^{UE} ) {T}_{c} \qquad [ Equation l ]$$

The terminal may obtain values N_{TA}, N_{TA,offset}, and T_{c} of Equation 1 as specified in the 3GPP specification. The terminal may obtain N_{TA,adj}^{common} and N_{TA,adj}^{UE} through a SIB broadcast from the switched satellite. Here, N_{TA,adj}^{common} may be a value proportional to a propagation delay between a reference point on the feeder link and the satellite, and may be a network-controlled common TA. According to the 3GPP specifications, the serving cell broadcasts parameters such as ta-Common, ta-CommonDrift, ta-CommonDriftVariant, etc. to terminals through a SIB19. Accordingly, the terminals may receive the parameters such as ta-Common, ta-CommonDrift, ta-CommonDriftVariant, etc. broadcast from the serving cell and use them to calculate N_{TA,adj}^{common}.

Here, ta-Common may be a common TA parameter and may be a common TA fixed value at an epoch time. In addition, ta-CommonDrift may be a primary change amount parameter for the common TA (i.e. drift rate of the common TA) and may indicate the amount of change in the common TA according to a time elapsed from the epoch time. ta-CommonDrift Variant may be a secondary change amount parameter for the common TA (i.e. drift rate variation of the common TA) and may indicate the amount of change in the common TA according to a time elapsed from the epoch time.

N_{TA,adj}^{UE} may be a value proportional to a distance between the terminal and the satellite and may be the terminal's own estimated TA. According to the 3GPP specifications, the serving cell may broadcast epoch time, ephemeris information, etc. to terminals through the SIB19. The terminal may receive epoch time, ephemeris information, etc. from the serving cell and use them to calculate N_{TA,adj}^{UE}.

Here, the epoch time may be provided through an epochTime field of the SIB19. The epochTime field may be a field that provides an epoch time of NTN assistance information. The NTN assistance information may be information related to ephemeris information of serving and/or neighbor satellites, UL TA information therefore, etc. The NTN assistance information may be NTN configuration information (e.g. NIN-Config) or information in the SIB19 including the NTN configuration information (e.g. NTN-Config). In other words, the epoch time may be time information provided through the SIB or dedicated signaling. Therefore, the epoch time may change differently each time the terminal receives the NTN assistance information. However, a value tag of SIB1 may not change due to a change in the epoch time.

The ephemeris information may be provided through an ephemerisInfo field of the SIB19. The ephemerisInfo field may be a field for providing satellite ephemeris information in a position and velocity state vector format or an orbital parameter format. However, a value tag of SIB1 may not change due to a change in the ephemeris information.

The terminal cannot obtain N_{TA,adj}^{common} and N_{TA,adj}^{UE} until it receives such the information included in the SIB broadcast from the switched satellite. The SIBs (i.e. SIB1 to SIB21) may be transmitted with different broadcasting periodicities set for the respective detailed messages according to a policy of the serving cell. In particular, the SIB19, which is closely related to NTN, may be transmitted at a periodicity of 5 to 5120 slots.

The terminal in the RRC connected state needs to quickly acquire DL/UL synchronization with the newly switched satellite in order to continue receiving services immediately after the SHS. However, the terminal cannot acquire the parameters for UL synchronization until the switched satellite broadcasts the required SIB. If the terminal cannot quickly acquire the parameters for UL synchronization, which may result in significant time delay in terms of service continuity. In this regard, improvements can be achieved if the terminal secures the parameters for uplink synchronization in advance when the switched satellite resumes services during the SHS procedure. Accordingly, the present disclosure proposes the following detailed method.

With the aim of quickly completing the SHS without changing the PCI, the serving cell may provide information on an upcoming replacement satellite to the terminal in advance, prior to the occurrence of the SHS. To this end, the serving cell may additionally broadcast the following information. As a result, the terminal may receive information on the replacement satellite broadcasted by the serving cell, and obtain details about the replacement satellite before the SHS occurs. Meanwhile, the present disclosure proposes two options.

### [Option 1]

If the satellite to be newly switched (i.e. replacement satellite) supports the unchanged PCI method, the serving cell may broadcast to terminals the parameters needed to calculate N_{TA,adj}^{common} and the parameters needed to calculate N_{TA,adj}^{UE} for the satellite to be newly switched. The parameters needed to calculate N_{TA,adj}^{common} and the parameters needed to calculate N_{TA,adj}^{UE} may include a time, orbit, delay time, etc. of the satellite to be newly switched. The parameters needed to calculate N_{TA,adj}^{common} may be, for example, ta-Common, ta-CommonDrift, ta-CommonDriftVariant, etc. In addition, the parameters needed to calculate N_{TA,adj}^{UE} may be, for example, epochTime, ephemerisInfo, etc.

### [Option 2]

If the satellite to be newly switched (i.e. replacement satellite) supports the unchanged PCI method, the serving cell may broadcast to terminals the parameters needed to calculate N_{TA,adj}^{common} and information needed to calculate N_{TA,adj}^{UE} for the satellite to be newly switched. The parameters needed to calculate N_{TA,adj}^{common} and the information needed to calculate N_{TA,adj}^{UE} may include a time, orbit, delay time, etc. of the satellite to be newly switched. The parameters needed to calculate N_{TA,adj}^{common} may be, for example, ta-Common, ta-CommonDrift, ta-CommonDriftVariant, etc. In addition, the information needed to calculate N_{TA,adj}^{UE} may be a position of information on the replacement satellite present in neighbor cell information broadcast through a SIB of the serving cell. Here, the position of information on the replacement satellite may be indicated by an index indicating the position of the information on the replacement satellite within a neighbor cell list.

Accordingly, the terminal may receive the index indicating the position of information on the replacement satellite present in the neighbor cell information broadcast through the SIB of the serving cell. The terminal may identify the corresponding neighbor cell in the neighbor cell list according to the received index. Then, the terminal may obtain the parameters needed to calculate N_{TA,adj}^{UE} from information related to the identified neighbor cell. In this case, the parameters needed to calculate N_{TA,adj}^{UE} may be, for example, epochTime, ephemerisInfo, etc. Since the terminal can know the location, speed, and direction of the replacement satellite in advance through epochTime, ephemerisInfo, etc., which are the parameters needed to calculate N_{TA,adj}^{UE}, the terminal may estimate the location, speed, and direction of the replacement satellite after the SHS.

Although the signal overhead of Option 1 proposed in the present disclosure is greater than that of Option 2, Option 1 may have an advantage of accurately calculating the location of the replacement satellite. Although Option 2 proposed in the present disclosure may have a somewhat large error in calculating the location of the replacement satellite, Option 2 may have an advantage of reducing signal overhead. The NTN may be operated by selecting at least one of the two options depending on its situation.

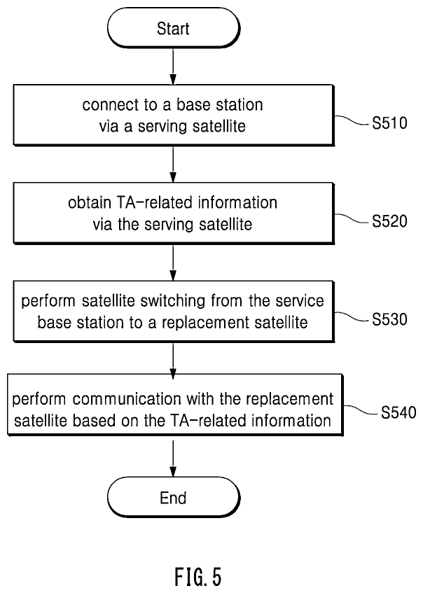

FIG. 5 is a flow chart illustrating a first exemplary embodiment of a satellite switching method in a non-terrestrial network.

Referring to FIG. 5, a terminal operating in the NTN system may be connected to a base station through on a service link of a serving satellite (S510). Accordingly, the base station may provide communication services to the terminal via the serving satellite. In addition, the base station may generate information related to a UL TA (i.e. UL TA-related information) of a replacement satellite. Then, the base station may transmit the UL TA-related information of the replacement satellite to the terminal through the service link of the serving satellite. Accordingly, the terminal may obtain the UL TA-related information of the replacement satellite through the service link of the serving satellite (S520). Thereafter, the base station may cause a satellite that provides communication services to the terminal to be switched from the serving satellite to the replacement satellite (S530), and the terminal may perform communication with the replacement satellite based on the UL TA-related information of the replacement satellite (S540).

Here, as an example, if the terminal does not receive random access indication information, the terminal may be connected to a service link of the replacement satellite based on the satellite switching without performing a random access procedure. In other words, if the terminal receives the UL TA-related information of the replacement satellite from the serving satellite, the terminal may connect to the replacement satellite without performing a random access procedure, and perform communication through the service link of the replacement satellite.

Here, the above-described operation may be performed based on the unchanged PCI method. For example, in the unchanged PCI method, the terminal may be connected to the base station based on a first cell provided by the serving satellite. After the satellite switching, the terminal may be connected to the base station based on a second cell provided by the replacement satellite. The first cell and the second cell may be quasi-Earth-fixed cells. Here, a PCI provided by the serving satellite of the first cell and a PCI provided by the replacement satellite of the second cell may be the same. In addition, a frequency resource of SSB(s) that the terminal receives from the serving satellite based on the first cell may be the same as a frequency resource of SSB(s) that the terminal receives from the replacement satellite based on the second cell.

As an example, if the service link of the serving satellite is interrupted based on the satellite switching and then the terminal is connected to the service link of the replacement satellite, the terminal may perform communication with the replacement satellite based on the UL TA-related information of the replacement satellite after switching to the replacement satellite based on the satellite switching. As another example, the terminal may be connected to the service link of the replacement satellite before the service link of the serving satellite is interrupted based on the satellite switching, and if the service link of the serving satellite is interrupted after the terminal is connected to the service link of the replacement satellite, the terminal may perform communication with the replacement satellite based on the UL TA-related information of the replacement satellite after switching to the replacement satellite based on the satellite switching.

Based on the UL TA-related information of the replacement satellite, which is obtained by the terminal, a UL TA of the replacement satellite may be determined and applied to communication with the replacement satellite. In addition, the UL TA-related information of the replacement satellite may be configured as at least one field or information element (IE) in a SIB that the terminal obtains through the service link of the serving satellite. In other words, the UL TA of the replacement satellite may be independently configured within the SIB, as described above. In addition, the terminal may receive an NTN-related SIB, and the UL TA-related information of the replacement satellite may be included in the NTN-related SIB. As an example, if a first field is present in the NTN-related SIB, the terminal may determine that the satellite switching is performed based on the unchanged PCI method. If data exists in a UL HARQ buffer based on the service link of the serving satellite, the terminal may reserve the data in the HARQ buffer during the satellite switching process, and perform a UL HARQ operation after switching to the replacement satellite.

The present disclosure includes proposals for detailed procedures related to an unchanged PCI handover method. The method of the present disclosure can enable the terminal to quickly acquire UL synchronization after SHS without having to wait until it receives the SIB broadcast by the replacement satellite.

In other words, through the method proposed above, a terminal in the RRC connected state can obtain the information needed to acquire UL synchronization with the replacement satellite before SHS occurs. Accordingly, the terminal can quickly acquire UL synchronization immediately after the SHS. Furthermore, the method of the present disclosure can reduce a temporary service interruption time due to handovers.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
obtaining, from a first satellite, uplink (UL) timing advance (TA)-related information for a second satellite;
performing satellite switching from the first satellite to the second satellite; and
performing communication with the second satellite based on the UL TA-related information.

2. The method according to claim 1, wherein the UL TA-related information includes at least one of information related to a network-controlled common TA for calculating a UL TA for the second satellite or information related to a TA estimated by the terminal.

3. The method according to claim 2, wherein the information related to the network-controlled common TA includes at least one of a common TA, a primary change amount parameter for the common TA, or a second change amount parameter for the common TA.

4. The method according to claim 2, wherein the information related to the TA estimated by the terminal includes information on an epoch time and ephemeris-related information.

5. The method according to claim 1, wherein in the performing of the communication with the second satellite, the terminal determines a UL TA for the second satellite based on the UL TA-related information after switching to the second satellite, and applies the determine UL TA to the communication with the second satellite.

6. The method according to claim 1, further comprising:
determining whether uplink data exists in a hybrid automatic repeat request (HARQ) buffer of the first satellite;
in response to determining that uplink data exists in the HARQ buffer, suspending transmission of the uplink data existing in the HARQ buffer in the performing of the satellite switching; and
transmitting the uplink data stored in the HARQ buffer after the satellite switching to the second satellite.

7. The method according to claim 1, wherein the first satellite and the second satellite are connected to a same base station, the first satellite forms a first quasi-Earth-fixed cell and the second satellite forms a second quasi-Earth-fixed cell, a physical cell identifier (PCI) of the first quasi-Earth-fixed cell is equal to a PCI of the second quasi-Earth-fixed cell, and a frequency resource through which a first synchronization signal block (SSB) received by the terminal is transmitted from the first satellite based on the first quasi-Earth-fixed cell is equal to a frequency resource through which a second SSB received by the terminal is transmitted from the second satellite based on the second quasi-Earth-fixed cell.

8. The method according to claim 1, wherein the performing of the communication with the second satellite comprises:
stopping communication services of the first satellite based on the satellite switching;
connecting to the second satellite based on the satellite switching; and
performing the communication with the second satellite through a service link based on the UL TA-related information.

9. The method according to claim 1, wherein the performing of the communication with the second satellite comprises:
connecting to the second satellite based on the satellite switching;
stopping communication services of the first satellite after connecting to the second satellite; and
performing the communication with the second satellite through a service link based on the UL TA-related information.

10. A method of a base station, comprising:
providing communication services to a terminal connected via a serving satellite;
generating uplink (UL) timing advance (TA)-related information for a target satellite; and
providing the UL TA-related information to the terminal via the serving satellite.

11. The method according to claim 10, wherein the base station transmits the UL TA-related information to the terminal by including the UL TA-related information in a system information block (SIB) 19.

12. The method according to claim 10, wherein the UL TA-related information includes at least one of information related to a network-controlled common TA for calculating a UL TA for the target satellite or information related to a TA estimated by the terminal.

13. The method according to claim 12, wherein the information related to the network-controlled common TA includes at least one of a common TA, a primary change amount parameter for the common TA, or a secondary change amount parameter for the common TA.

14. The method according to claim 12, wherein the information related to the TA estimated by the terminal includes information on an epoch time and ephemeris-related information.

15. The method according to claim 10, further comprising:
performing satellite switching of a satellite providing communication services to the terminal from the serving satellite to the target satellite; and
providing communication services to the terminal via the target satellite based on the UL TA-related information for the target satellite.

16. A terminal comprising a processor, wherein the processor causes the terminal to perform:
obtaining, from a first satellite, uplink (UL) timing advance (TA)-related information for a second satellite;
performing satellite switching from the first satellite to the second satellite; and
performing communication with the second satellite based on the UL TA-related information.

17. The terminal according to claim 16, wherein the UL TA-related information includes at least one of information related to a network-controlled common TA for calculating a UL TA for the second satellite or information related to a TA estimated by the terminal.

18. The terminal according to claim 16, wherein the information related to the network-controlled common TA includes at least one of a common TA, a primary change amount parameter for the common TA, or a second change amount parameter for the common TA.

19. The terminal according to claim 16, wherein the information related to the TA estimated by the terminal includes information on an epoch time and ephemeris-related information.

20. The terminal according to claim 16, wherein in the performing of the communication with the second satellite, the processor causes the terminal to determine a UL TA for the second satellite based on the UL TA-related information after switching to the second satellite, and apply the determine UL TA to the communication with the second satellite.
